(19) United States
(12) Patent Application Publication
(10) Pub. No.: US 2026/0301674 A1
(43) Pub. Date: Oct. 1, 2026

(54) DISPLAY DEVICE AND ELECTRONIC APPARATUS INCLUDING THE SAME

(71) Applicant: Samsung Display Co., LTD., Yongin-si (KR)

(72) Inventors: SEOKHA HONG, Yongin-si (KR); GIGEUN KIM, Yongin-si (KR); KANGHEE LEE, Yongin-si (KR)

(21) Appl. No.: 19/533,890

(22) Filed: Feb. 9, 2026

(30) Foreign Application Priority Data
Mar. 26, 2025 (KR) 10-2025-0038857

(51) Int. Cl. G09G 3/3233

(52) U.S. Cl. CPC G09G 3/3233; G09G 2310/08; G09G 2320/0257; G09G 2330/021

(57) ABSTRACT

A display device includes a display panel in which a plurality of pixels are arranged, and an afterimage compensation circuit which compensates input image signals based on deterioration information on the display panel to generate compensation image signals. The afterimage compensation circuit includes a deterioration data generation unit which generates deterioration data for the display panel for each sampling period, a deterioration data compensation unit which calculates an average frequency based on a reference frequency and a number of sampling frames generated in the sampling period, and applies the average frequency to the deterioration data to generate final deterioration data, a accumulating memory in which the final deterioration data is accumulated, and a compensation unit which receives the accumulated deterioration data stored in the accumulative memory as the deterioration information, compensates for the input image signals based on the accumulated deterioration data, and generates the compensation image signals.

This application claims priority to Korean Patent Application No. 10-2025-0038857, filed on Mar. 26, 2025, and all the benefits accruing therefrom under 35 U.S.C. § 119, the content of which in its entirety is herein incorporated by reference.

### BACKGROUND

### (1) Field

Embodiments of the present disclosure relate to a display device and an electronic apparatus including the display device, and more particularly, relate to a display device capable of compensating for an afterimage and an electronic apparatus including the display device.

### (2) Description of the Related Art

A light-emitting display device among display devices displays an image using a light emitting diode which generates light through recombination of electrons and holes. The light-emitting display device may have a fast response speed and be driven with low power consumption.

The light-emitting display device may include a display panel in which pixels connected to data lines and scan lines are disposed. The pixels generally include a light-emitting diode and a pixel circuit unit for controlling the amount of current flowing into the light-emitting diode. The pixel circuit unit controls the amount of current flowing through the light-emitting diode in response to a data signal. In this case, light of predetermined luminance is generated corresponding to the amount of current flowing through the light-emitting diode.

### SUMMARY

light-emitting display device, luminance deviation and afterimages occur between the pixels due to deterioration of pixels or deterioration of light-emitting diodes.

Embodiments of the present disclosure provide a display device capable of effectively compensating for an afterimage even under a frequency varying condition, and an electronic apparatus including the same.

According to an embodiment, a display device present disclosure includes a display panel in which a plurality of pixels are disposed, and an afterimage compensation circuit which receives an input image signal, and compensates the input image signal based on deterioration information about the display panel to generate a compensation image signal.

In such an embodiment, the afterimage compensation circuit includes a deterioration data generation unit which generates deterioration data for the display panel for each sampling period, a deterioration data compensation unit which calculates an average frequency based on a reference frequency and a number of sampling frames generated in the sampling period, and applies the average frequency to the deterioration data to generate final deterioration data, a accumulating memory in which the final deterioration data is accumulated, and a compensation unit which receives accumulated deterioration data stored in the accumulating memory as the deterioration information, and compensates the input image signal based on the accumulated deterioration data to generate the compensation image signal.

According to an embodiment, an electronic apparatus present disclosure includes a display panel in which a plurality of pixels are disposed, a driving controller including an afterimage compensation circuit which receives an input image signal and compensates the input image signal based on deterioration information about the display panel to generate a compensation image signal, and a processor which provides the input image signal to the driving controller.

In such an embodiment, the afterimage compensation circuit includes a deterioration data generation unit which generates deterioration data for the display panel for each sampling period, a deterioration data compensation unit which calculates an average frequency based on a reference frequency and a number of sampling frames generated in the sampling period, and applies the average frequency to the deterioration data to generate final deterioration data, a accumulating memory in which the final deterioration data is accumulated, and a compensation unit which receives accumulated deterioration data stored in the accumulating memory as the deterioration information, and compensates the input image signal based on the accumulated deterioration data to generate the compensation image signal.

In embodiments of the present disclosure, even when the driving frequency of the display panel is varied during the sampling period in the variable frequency mode or the multi-frequency mode, information on the driving frequency can be reflected in the final deterioration data as the average frequency. As a result, as the input image signal is compensated based on the final deterioration data, it is possible to effectively prevent the input image signal from being incorrectly compensated in the variable frequency mode or the multi-frequency mode.

### BRIEF DESCRIPTION OF THE DRAWINGS

The above and other objects of embodiments of the present disclosure will become apparent by describing in detail embodiments thereof with reference to the accompanying drawings.

FIG. 1 is a perspective view of an electronic apparatus according to an embodiment of the present disclosure.

FIG. 2A is an exploded perspective view of an electronic apparatus according to an embodiment of the present disclosure.

FIG. 2B is a cross-sectional view of a display device according to an embodiment of the present disclosure.

FIG. 3 is a block diagram of a display device according to an embodiment of the present disclosure.

FIG. 4 is a circuit diagram of a pixel according to an embodiment of the present disclosure.

FIG. 5A is a signal timing diagram for describing an operation of a display panel operating at a first driving frequency according to an embodiment of the present disclosure.

FIG. 5B is a signal timing diagram for describing an operation of a display panel operating at a second driving frequency according to an embodiment of the present disclosure.

FIG. 6A is a block diagram of an afterimage compensation circuit according to an embodiment of the present disclosure.

FIG. 6B is a block diagram of the deterioration data compensation unit shown in FIG. 6A.

FIG. 7 is a signal timing diagram for describing an operation of the deterioration data compensation unit illustrated in FIG. 6B.

FIG. 8 is a plan view of a display panel according to an embodiment of the present disclosure.

FIGS. 9A to 9C are diagrams illustrating a sampling process for each of sampling periods according to an embodiment of the present disclosure.

FIG. 10 is a plan view illustrating a screen of a display device according to an embodiment of the present disclosure.

FIG. 11A is a diagram for describing an operation of a display device in a normal frequency mode according to an embodiment of the present disclosure.

FIG. 11B is a diagram for describing an operation of a display device in a multi-frequency mode according to an embodiment of the present disclosure.

FIG. 12 is a block diagram of an afterimage compensation circuit according to an embodiment of the present disclosure.

FIG. 13 is a signal timing diagram for describing an operation of the deterioration data compensation unit illustrated in FIG. 12.

FIG. 14 is a block diagram of an electronic apparatus according to an embodiment of the present disclosure.

FIG. 15 is a schematic diagram illustrating electronic apparatus in accordance with various embodiments.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present therebetween. In contrast, when an element is referred to as being “directly on” another element, there are no intervening elements present. In this specification, it will be understood that when an element (or a region, a layer, a portion, or the like) is referred to as being “connected to” or “coupled to” another element, it may be directly connected to, or coupled to the other element, or other elements may be disposed therebetween.

Like reference numerals or symbols refer to like elements throughout. In the drawings, the thickness, ratio, and size of the elements are exaggerated for effectively describing the technical contents.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. “About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of the invention are described with reference to the drawings.

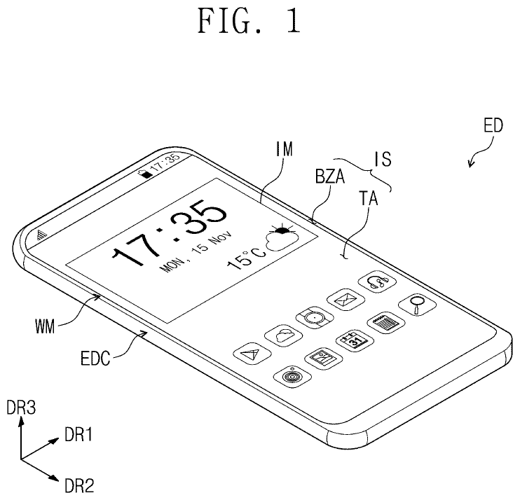

FIG. 1 is a perspective view of an electronic apparatus according to an embodiment of the present disclosure.

Referring to FIG. 1, an electronic apparatus ED according to an embodiment of the present disclosure may have a rectangular planar shape having short sides parallel to a first direction DR1 and long sides parallel to a second direction DR2 intersecting the first direction DR1. However, embodiments of the present disclosure are not limited thereto, the electronic apparatus ED may have various shapes, such as a circular shape or a polygonal shape.

The electronic apparatus ED may be a device activated depending on an electrical signal. The electronic apparatus ED may include various embodiments. In an embodiment, for example, the electronic apparatus ED may be applied to an electronic apparatus including a display device such as a smart phone, a smart watch, a tablet, a notebook computer, a computer, a smart television, and a navigation system.

Hereinafter, a normal direction substantially perpendicular to a plane defined by the first direction DR1 and the second direction DR2 is defined as a third direction DR3. Here, the third direction DR3 may be a thickness direction of the electronic apparatus ED. In the present specification, “in a plan view” may mean a state viewed in the third direction DR3.

An upper surface of the electronic apparatus ED may be defined as a display surface IS and may be parallel to a plane defined by the first direction DR1 and the second direction DR2. Images IM generated by the electronic apparatus ED may be provided to a user through the display surface IS.

The display surface IS may be divided into a transmission region TA and a bezel region BZA. The transmission region TA may be a region in which images IM are displayed. The user visually perceives the images IM through the transmission region TA. In an embodiment, the transmissive region TA may be in a square shape with rounded vertices as shown in FIG. 1. However, the transmissive region TA is illustrated by way of example, and the transmissive region TA may have various shapes, and be not limited to any one embodiment.

The bezel region BZA is adjacent to the transmission region TA. The bezel region BZA may have a predetermined color. The bezel region BZA may surround the transmission region TA. Accordingly, the shape of the transmission region TA may be substantially defined by the bezel region BZA. However, the bezel region BZA is illustrated by way of example, and the bezel region BZA may be disposed adjacent to only one side of the transmission region TA or may be omitted.

The electronic apparatus ED may sense an external input applied from the outside. The external input may include various types of inputs provided the outside of the electronic apparatus ED. In an embodiment, for example, the external input may include contact by a part of the user's body, such as a user's hand, or contact by a separate device (e.g., an active pen or digitizer), as well as external input (e.g., hovering) applied proximate to or adjacent to the electronic apparatus ED by a predetermined distance. In addition, the external input may have various forms such as force, pressure, temperature, light, and the like.

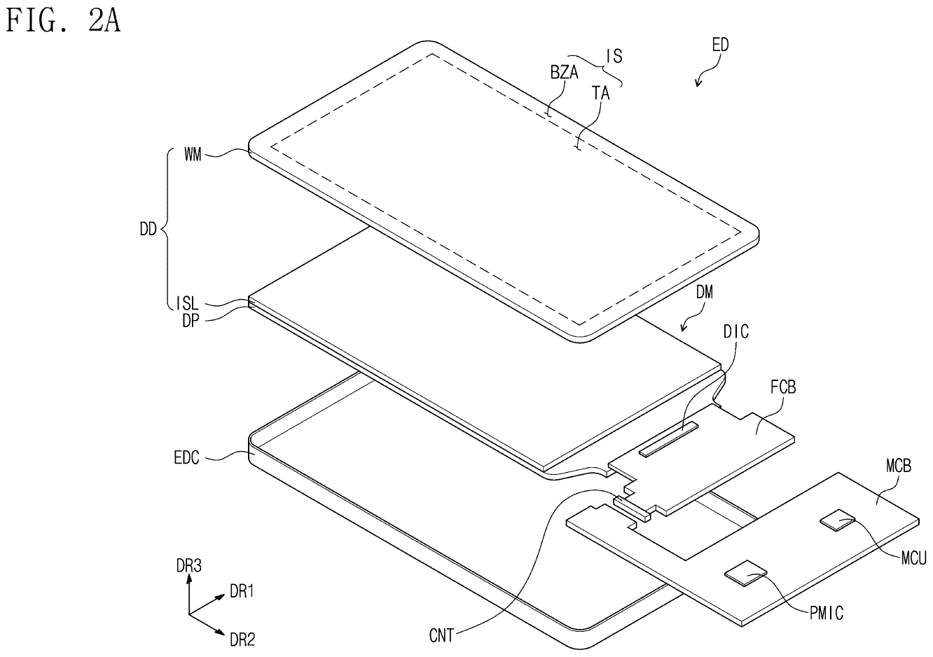

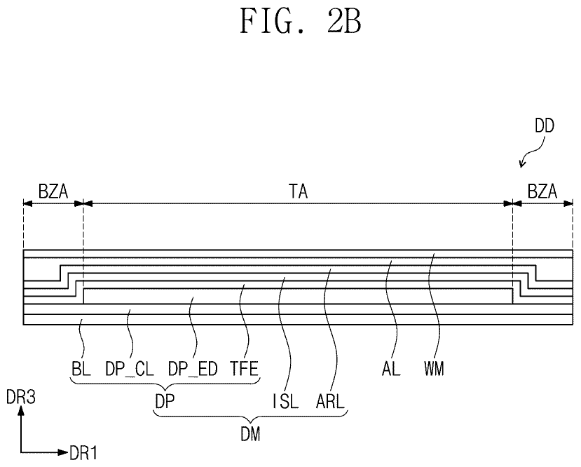

FIG. 2A is an exploded perspective view of an electronic apparatus according to an embodiment of the present disclosure, and FIG. 2B is a cross-sectional view of a display device according to an embodiment of the present disclosure.

Referring to FIGS. 2A and 2B, an embodiment of the electronic apparatus ED may include a display device DD, an electronic module, and a housing EDC. The display device DD includes a window WM and a display module DM, and may be accommodated in a housing EDC. In an embodiment, the window WM and the housing EDC are coupled to constitute the appearance of the electronic apparatus ED.

A front surface of the window WM defines the display surface IS of the electronic apparatus ED. The window WM may include an optically transparent insulating material. In an embodiment, for example, the window WM may include glass or plastic. The window WM may have a multi-layer structure or a single-layer structure. In an embodiment, for example, the window WM may include a plurality of plastic films bonded to each other with an adhesive, or may include a glass substrate and a plastic film bonded to each other with the adhesive.

The display module DM may include a display panel DP and an input sensing layer ISL. The display panel DP may display an image based on an electrical signal, and the input sensing layer ISL may sense an external input applied from the outside. The external input may be provided in various forms.

The display panel DP according to an embodiment of the present disclosure may be a light-emitting display panel, and is not particularly limited thereto. In an embodiment, for example, the display panel DP may be an organic light emitting display panel, an inorganic light emitting display panel or a quantum dot light emitting display panel. The light-emitting layer of the organic light-emitting display panel may include an organic light-emitting material, and the light-emitting layer in the inorganic light-emitting display panel may include an inorganic light-emitting material. The light-emitting layer of the quantum dot light-emitting display panel may include a quantum dot, a quantum rod, and the like. Hereinafter, for convenience of description, embodiments where the display panel DP is the organic light-emitting display panel will be mainly described.

Referring to FIG. 2B, an embodiment of the display panel DP includes a base layer BL, a circuit layer DP_CL, an element layer DP_ED, and an encapsulation layer TFE. The display panel DP according to an embodiment of the present disclosure may be a flexible display panel. However, embodiments of the present disclosure are not limited thereto. In an embodiment, for example, the display panel DP may be a foldable display panel that is folded with respect to a folding axis or a rigid display panel.

The base layer BL may include a synthetic resin layer. The synthetic resin layer may be a polyimide-based resin layer, and the material of the synthetic resin layer is not particularly limited. In addition, the base layer BL may include a glass substrate, a metal substrate, an organic/inorganic composite material substrate, or the like.

The circuit layer DP_CL is disposed on the base layer BL. The circuit layer DP_CL is disposed between the base layer BL and the element layer DP_ED. The circuit layer DP_CL includes at least one insulating layer and a circuit element. Hereinafter, the insulating layer included in the circuit layer DP_CL is referred to as an intermediate insulating layer. The intermediate insulating layer includes at least one intermediate inorganic layer and at least one intermediate organic layer. The circuit element may include a pixel driving circuit included in each of the plurality of pixels for displaying an image, a sensor driving circuit included in each of the plurality of sensors for recognizing external information, and the like. The external information may be biometric information. In an embodiment, for example, the sensor may be a fingerprint recognition sensor, a proximity sensor, an iris recognition sensor, a blood pressure measurement sensor, an illuminance sensor, or the like. In an embodiment, for example, the sensor may be an optical sensor that recognizes the biometric information in an optical manner. The circuit layer DP_CL may further include signal lines connected to the pixel driving circuit and/or the sensor driving circuit.

The element layer DP_ED may include a light emitting element included in each of the pixels and a light receiving element included in each the sensors. In an embodiment, for example, the light receiving element may be a photodiode. The light receiving element may be a sensor that senses or reacts to light reflected by a user's fingerprint.

The encapsulation layer TFE seals the element layer DP_ED. The encapsulation layer TFE may include at least one organic layer and at least one inorganic layer. The inorganic layer includes an inorganic material, and may protect the element layer DP_ED from moisture/oxygen. The inorganic film may include, but is not particularly limited to, a silicon nitride layer, a silicon oxy nitride layer a silicon oxide layer, a titanium oxide layer, an aluminum oxide layer, or the like. The organic layer includes an organic material, and may protect the element layer DP_ED from foreign substances such as dust particles.

The input sensing layer ISL may be formed on the display panel DP. The input sensing layer ISL may be disposed directly on the encapsulation layer TFE. According to an embodiment of the present disclosure, the input sensing layer ISL may be formed on the display panel DP by a continuous process. That is, in an embodiment where the input sensing layer ISL is directly disposed on the display panel DP, the adhesive film is not disposed between the input sensing layer 1SL and the encapsulation layer TFE. Alternatively, an adhesive film may be disposed between the input sensing layer ISL and the display panel DP. In such an embodiment, the input sensing layer ISL is not manufactured by a continuous process with the display panel DP, and may be manufactured through a process separate from the display panel DP and then fixed to the upper surface of the display panel DP by the adhesive film.

The input sensing layer ISL may sense an external input (for example, a user's touch), change the external input to a input signal, and provide the input signal to the display panel DP. The input sensing layer ISL may include a plurality of sensing electrodes to sense the external input. The sensing electrodes may sense the external input in a capacitive manner. The display panel DP may receive the input signal from the input sensing layer ISL and generate an image corresponding to the input signal.

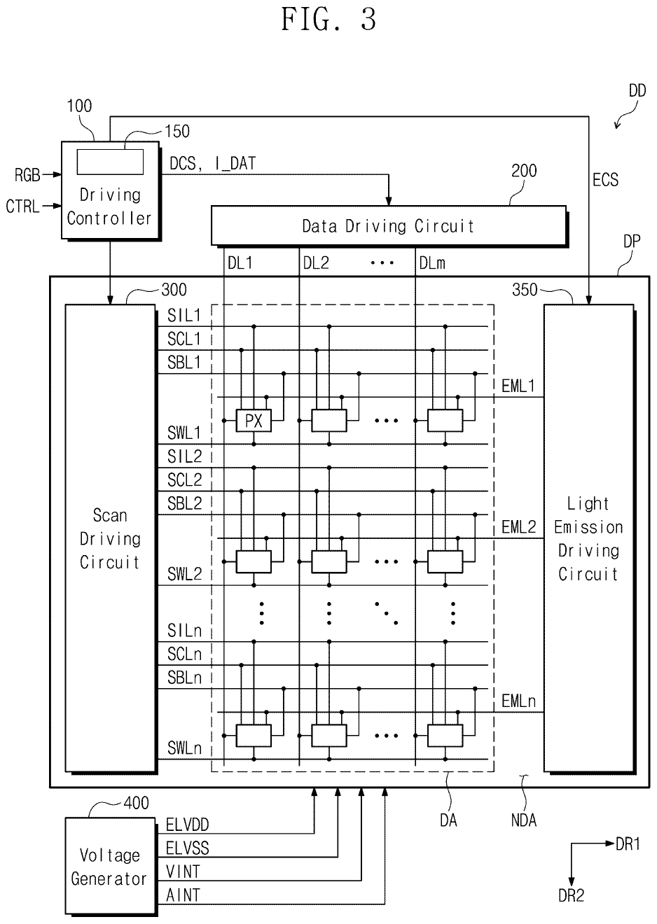

The display module DM may further include an anti-reflection layer ARL. The anti-reflection layer ARL reduces the reflectance of external light incident from the upper side of the window WM. In an embodiment, for example, the anti-reflection layer ARL may be disposed on the input sensing layer ISL. However, embodiments of the present disclosure are not limited thereto. The anti-reflection layer ARL may be disposed between the display panel DP and the input sensing layer ISL. The antireflection layer ARL may include a plurality of color filters and a black matrix. An arrangement of color filters may be determined in consideration of colors of light generated by a plurality of pixels PX (see FIG. 3) included in the display panel DP. Alternatively, the anti-reflection layer ARL may include a phase retarder and a polarizer. The phase retarder may be a phase retarder of a film type or a phase retarder of a liquid crystal coating type, and may include a λ/2 retarder and/or a λ/4 retarder. The polarizer may also be a polarizer of a film type or a polarizer of a liquid crystal coating type. The polarizer of the film type includes a stretchable synthetic resin film, and the polarizer of the liquid crystal coating type may include liquid crystals arranged in a predetermined arrangement. The phase retarder and the polarizer may be implemented as one polarizing film.

The display device DD according to an embodiment of the present disclosure may further include an adhesive layer AL. The window WM may be attached to the anti-reflection layer ARL by the adhesive layer AL. The adhesive layer AL may include an optical clear adhesive, an optical clear adhesive resin, or a pressure sensitive adhesive (PSA).

The display module DM may further include a display driving circuit DIC (or a display driving chip) and a flexible circuit film FCB. In an embodiment, for example, the display driving circuit DIC may be configured in the form of a chip and mounted on the flexible circuit film FCB. However, embodiments of the present disclosure are not limited thereto. Alternatively, the display driving circuit DIC may be disposed on the display panel DP.

The flexible circuit film FCB may be coupled to the display panel DP. The flexible circuit film FCB may be coupled to one end of the display panel DP to electrically connect the display driving circuit DIC to the display panel DP.

The display module DM may further include a touch driving circuit mounted on the flexible circuit film FCB and electrically connected to the input sensing layer ISL.

The electronic module may include a main circuit board MCB. In an embodiment, for example, the main circuit board MCB may be electrically connected to the flexible circuit film FCB through a connector CNT. The main circuit board MCB may include a processor MCU and a power management circuit PMIC (or a power management chip). The processor MCU and the power management circuit PMIC may be electrically connected to the display driving circuit DIC through the connector CNT.

The processor MCU may control the overall operation of the electronic apparatus ED. The processor MCU may include at least one selected from a central processing unit (CPU) or an application processor (AP). The processor MCU may further include at least one selected from a graphic processing unit (GPU), a communication processor (CP), and an image signal processor (ISP). The processor MCU may provide image signals and various control signals necessary for displaying an image to the display driving circuit DIC.

The power management circuit PMIC may receive an external power source (e.g., a battery voltage). In an embodiment, for example, the power management circuit PMIC may generate a voltage to be supplied to the display device DD based on an external power source. The power management circuit PMIC may include at least one regulator. The at least one regulator may generate output voltages having various voltage levels based on the external power source.

Although FIG. 2A illustrates an embodiment having a structure in which the power management circuit PMIC is mounted on the main circuit board MCB in the form of a chip, embodiments of the present disclosure are not limited thereto. In another embodiment, for example, the power management circuit PMIC may be provided in a configuration included in the display device DD, such as being mounted in the form of a chip on the flexible circuit film FCB.

The electronic module may further include various functional modules, for example, a camera module, a sensor module, and the like, in addition to the main circuit board MCB, the processor MCU, the power management circuit PMIC, and the like.

The housing EDC is coupled with the window WM. The housing EDC is coupled with the window WM to provide a predetermined internal space. The display device DD and the electronic module may be accommodated in an internal space of the housing EDC. The housing EDC may include a material having relatively high rigidity. In an embodiment, for example, the housing EDC may include a plurality of frames and/or plates, including glass, plastic, or metal, or a combination thereof. The housing EDC may reliably protect the components of the display device DD and the electronic module accommodated in the internal space from an external impact.

Although not shown, a battery module or the like that supplies power used for overall operation of the electronic apparatus ED may be disposed between the display module DM and the housing EDC.

FIG. 3 is a block diagram of a display device according to an embodiment of the present disclosure.

Referring to FIG. 3, an embodiment of the display device DD includes a display panel DP, a driving controller 100, a data driving circuit 200, a scan driving circuit 300, a light emission driving circuit 350, and a voltage generator 400.

The driving controller 100 receives input image signals RGB and control signals CTRL from the processor MCU (see FIG. 2A). The control signal CTRL may include a vertical synchronization signal, an input data enable signal, a master clock signal, or the like. The driving controller 100 generates a first driving control signal SCS, a second driving control signal DCS, and a third driving control signal ECS based on the control signal CTRL. The driving controller 100 may be referred to as a timing controller.

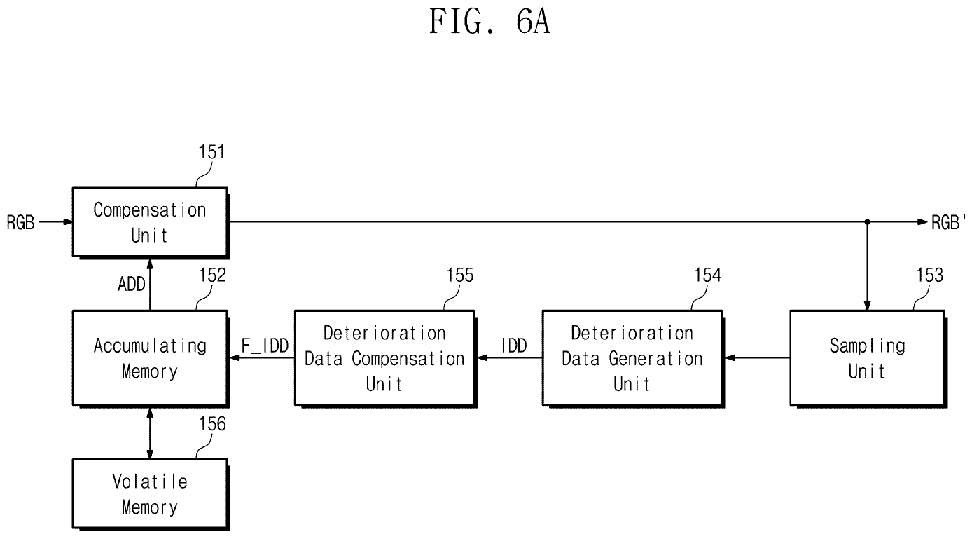

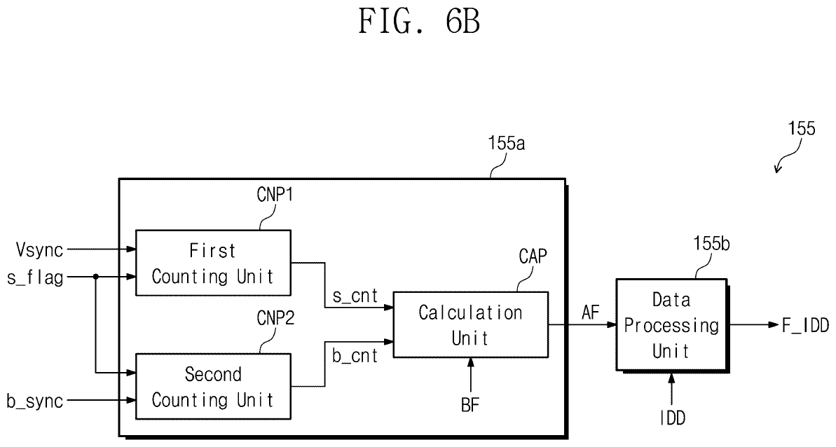

In an embodiment, for example, the driving controller 100 may include an afterimage compensation circuit 150. The afterimage compensation circuit 150 receives the input image signals RGB and compensates the input image signals RGB based on the deterioration information to generate compensation image signals RGB′ (see FIG. 6). The driving controller 100 generates image data I_DAT by converting the data format of the compensation image signals RGB′ to meet the interface specification with the data driving circuit 200. FIG. 3 illustrates an embodiment having a structure in which the afterimage compensation circuit 150 is included in the driving controller 100 as an example, but embodiments of the present disclosure are not limited thereto. In another embodiment, for example, the afterimage compensation circuit 150 is not included in the driving controller 100, and may be provided in a configuration independent of the driving controller 100.

The data driving circuit 200 receives the second driving control signal DCS and the image data I_DAT from the driving controller 100. The data driving circuit 200 converts the image data I_DAT into data signals, and outputs the data signals to a plurality of data lines DL1 to DLm to be described later. The data signals are analog voltages corresponding to grayscale values of the image data I_DAT. Here, m is an integer of 1 or more.

The scan driving circuit 300 receives the first driving control signal SCS from the driving controller 100. The scan driving circuit 300 may output scan signals to the scan lines in response to the first driving control signal SCS.

The voltage generator 400 generates voltages used for operation of the display panel DP. In an embodiment, the voltage generator 400 generates a first driving voltage ELVDD, a second driving voltage ELVSS, a first initialization voltage VINT, and a second initialization voltage AINT.

The display panel DP includes initialization scan lines SIL1 to SILn, compensation scan lines SCL1 to SCLn, write scan lines SWL1 to SWLn, black scan lines SBL1 to SBLn, light emission control lines EML1 to EMLn, data lines DL1 to DLm, and pixels PX. Here, n and m are natural numbers greater than 1. The initialization scan lines SIL1 to SILn, the compensation scan lines SCL1 to SCLn, the write scan lines SWL1 to SWLn, the black scan lines SBL1 to SBLn, the light emission control lines EML1 to EMLn, the data lines DL1 to DLm, and the pixels PX may overlap a display area DA. The initialization scan lines SIL1 to SILn, the compensation scan lines SCL1 to SCLn, the write scan lines SWL1 to SWLn, the black scan lines SBL1 to SBLn, and the light emission control lines EML1 to EMLn extend in the first direction DR1. The initialization scan lines SIL1 to SILn, the compensation scan lines SCL1 to SCLn, the write scan lines SWL1 to SWLn, the black scan lines SBL1 to SBLn, and the light emission control lines EML1 to EMLn are arranged to be spaced apart from each other in the second direction DR2. The data lines DL1 to DLm extend in the second direction DR2 and are arranged to be spaced apart from each other in the first direction DR1.

The plurality of pixels PX are electrically connected to the initialization scan lines SIL1 to SILn, the compensation scan lines SCL1 to SCLn, the write scan lines SWL1 to SWLn, the black scan lines SBL1 to SBLn, the light emission control lines EML1 to EMLn, and the data lines DL1 to DLm, respectively. Each of the plurality of pixels PX may be electrically connected to four scan lines. In an embodiment, for example, the pixels of the first row may be connected to the first initialization scan line SIL1, the first compensation scan line SCL1, the first write scan line SWL1, and the first black scan line SBL1. In such an embodiment, the pixels of the second row may be connected to the second initialization scan line SIL2, the second compensation scan line SCL2, the second write scan line SWL2, and the second black scan line SBL2. However, the number of scan lines connected to each pixel PX is not limited thereto and may vary in various ways.

The scan driving circuit 300 may be disposed in a non-display area NDA of the display panel DP. The scan driving circuit 300 receives the first driving control signal SCS from the driving controller 100. The scan driving circuit 300 outputs initialization scan signals to the initialization scan lines SIL1 to SILn and compensation scan signals to the compensation scan lines SCL1 to SCLn in response to the first driving control signal SCS. In addition, the scan driving circuit 300 may output write scan signals to the write scan lines SWL1 to SWLn and black scan signals to the black scan lines SBL1 to SBLn in response to the first driving control signal SCS.

The light emission driving circuit 350 receives the third driving control signal ECS from the driving controller 100. The light emission driving circuit 350 may output light emission control signals to the light emission control lines EML1 to EMLn in response to the third driving control signal ECS. In another embodiment, the scan driving circuit 300 may be connected to the light emission control lines EML1 to EMLn. In such an embodiment, the scan driving circuit 300 may output the light emission control signals to the light emission control lines EML1 to EMLn.

Each of the plurality of pixels PX includes a light emitting element and a pixel circuit unit that controls light emission of the light emitting element. The pixel circuit unit may include a plurality of transistors and a capacitor. The scan driving circuit 300 and the light emission driving circuit 350 may include transistors formed through the same process as the pixel circuit unit.

Each of the plurality of pixels PX receives the first driving voltage ELVDD, the second driving voltage ELVSS, the first initialization voltage VINT, and the second initialization voltage AINT from the voltage generator 400.

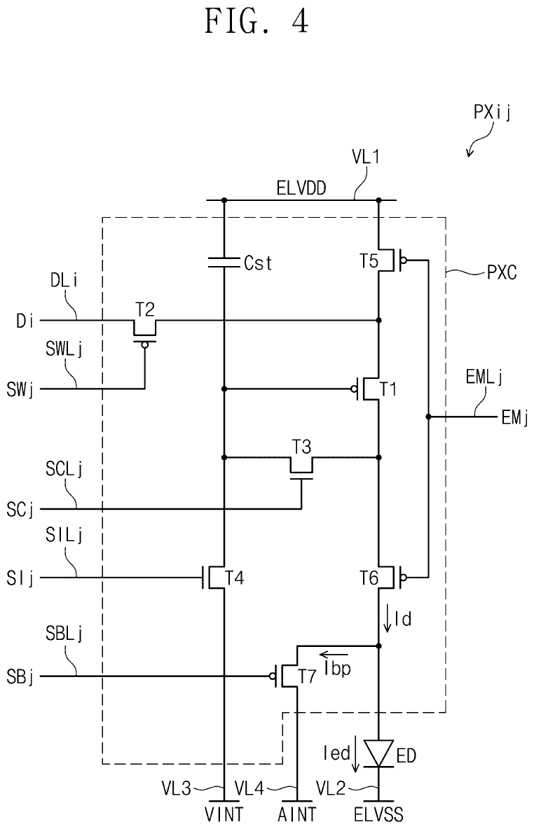

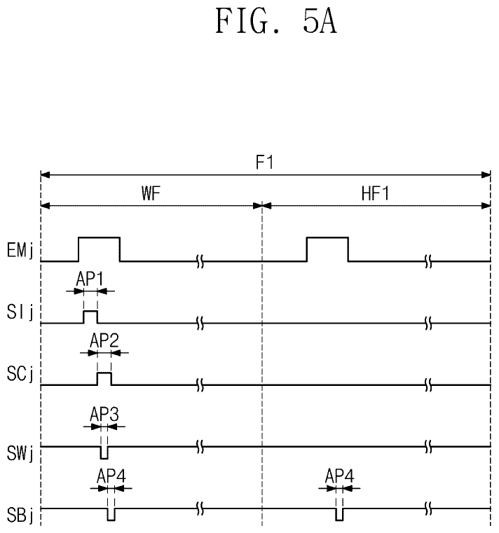

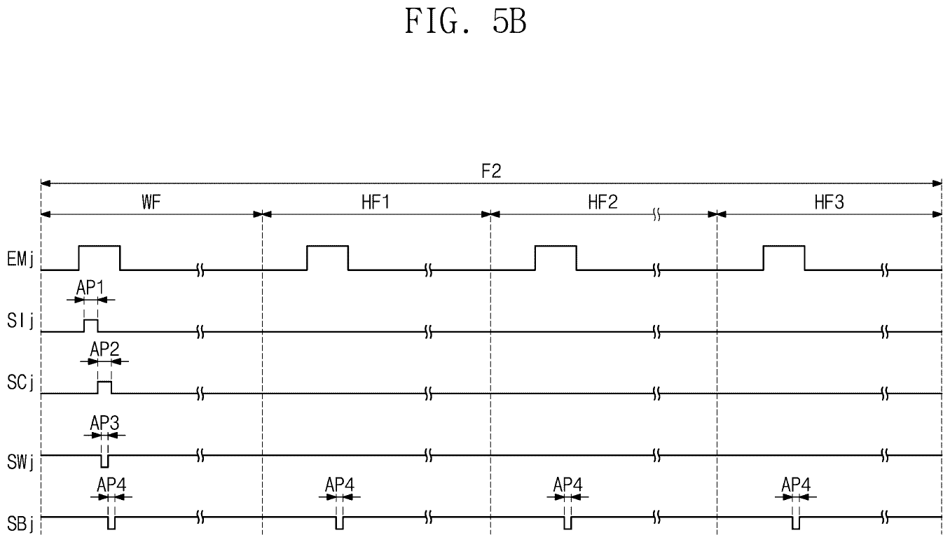

FIG. 4 is a circuit diagram of a pixel according to an embodiment of the present disclosure. FIG. 5A is a signal timing diagram for describing an operation of a display panel operating at a first driving frequency according to an embodiment of the present disclosure. FIG. 5B is a signal timing diagram for describing an operation of a display panel operating at a second driving frequency according to an embodiment of the present disclosure.

FIG. 4 illustrates an equivalent circuit diagram of one pixel PXij among the plurality of pixels PX illustrated in FIG. 3. Since each of the plurality of pixels PX has a same circuit structure as each other, only the circuit structure of the pixel PXij will be described, and additional descriptions of the remaining pixels will be omitted to avoid redundancy.

Referring to FIG. 4, the pixel PXij is connected to an i-th data line DLi (hereinafter referred to as a data line) among the data lines DL1 to DLm and a j-th light emission control line EMLj (hereinafter referred to a light emission control line) among the light emission control lines EML1 to EMLn. The pixel PXij is connected to a j-th initialization scan line SILj among the initialization scan lines SIL1 to SILn (hereinafter, referred to as an initialization scan line) and a j-th write scan line SWLj among the write scan lines SWL1 to SWLn (hereinafter, referred to as a write scan line). In addition, the pixel PXij is connected to a j-th compensation scan line SCLj (hereinafter, referred to as a compensation scan line) among the compensation scan lines SCL1 to SCLn and a j-th black scan line SBLj (hereinafter, referred to as a black scan line) among black scan lines SBL1 to SBLn.

The pixel PXij includes a light emitting element ED and a pixel circuit unit PXC. The light emitting element ED may include a light emitting diode. The light emitting diode may include an organic light emitting material, an inorganic light emitting material, a quantum dot, a quantum rod, or the like as a light emitting layer.

The pixel circuit unit PXC includes first to seventh transistors T1, T2, T3, T4, T5, T6, and T7 and one capacitor Cst. Each of the first to seventh transistors T1 to T7 may be a transistor having a low-temperature polycrystalline silicon (LTPS) semiconductor layer. Some of the first to seventh transistors T1 to T7 may be P-type transistors, and others may be N-type transistors. In an embodiment, for example, among the first to seventh transistors T1 to T7, the first, second, and fifth to seventh transistors T1, T2, and T5 to T7 may be P-type transistors, and the third and fourth transistors T3 and T4 may be N-type transistors having an oxide semiconductor as a semiconductor layer. However, the configuration of the pixel circuit unit PXC according to an embodiment of the present disclosure is not limited to the embodiment shown in FIG. 4. The pixel circuit unit PXC illustrated in FIG. 4 is merely an example, and the configuration of the pixel circuit unit PXC may be modified and implemented. In an embodiment, for example, all of the first to seventh transistors T1 to T7 may be P-type transistors or N-type transistors.

The initialization scan line SILj, the compensation scan line SCLj, the write scan line SWLj, the black scan line SBLj, and the light emission control line EMLj may apply a j-th initialization scan signal SIj (hereinafter, referred to as an initialization scan signal), a j-th compensation scan signal SCj (hereinafter, referring to as a compensation scan signal), a j-th write scan signal SWj (hereinafter, refer to as a write scan signal), a j-th black scan signal SBj (hereinafter, referred to as a black scan signal), and a j-th light emission control signal EMLj (hereinafter, referred to as a light emission control signal) to the pixel PXij, respectively. The data line DLi applies a data signal Di to the pixel PXij. The data signal Di may have a voltage level corresponding to the grayscale of the image data I_DAT (see FIG. 3). The first to fourth driving voltage lines VL1, VL2, VL3, and VL4 may transmit the first driving voltage ELVDD, the second driving voltage ELVSS, the first initialization voltage VINT, and the second initialization voltage AINT to the pixel PXij, respectively.

The first transistor T1 includes a first electrode connected to the first driving voltage line VL1 through a fifth transistor T5, a second electrode electrically connected to an anode of the light emitting element ED through a sixth transistor T6, and a gate electrode connected to one end of the capacitor Cst. The first transistor T1 may receive the data signal Di transmitted from the data line DLi depending on the switching operation of the second transistor T2 to supply the driving current Id to the light emitting element ED.

The second transistor T2 includes a first electrode connected to the data line DLi, a second electrode connected to the first electrode of the first transistor T1, and a gate electrode connected to the write scan line SWLj. The second transistor T2 may be turned on in response to the write scan signal SWj received through the write scan line SWLj to provide the data signal Di transmitted from the data line DLi to the first electrode of the first transistor T1.

The third transistor T3 includes a first electrode connected to the second electrode of the first transistor T1, a second electrode connected to the gate electrode of the first transistor T1, and a gate electrode connected to the compensation scan line SCLj. The third transistor T3 may be turned on in response to the compensation scan signal SCj received through the compensation scan line SCLj, and thus the gate electrode of the first transistor T1 and the second electrode of the first transistor T1 may be connected to each other such that the first transistor T1 may be diode-connected.

The fourth transistor T4 includes a first electrode connected to the gate electrode of the first transistor T1, a second electrode connected to the third driving voltage line VL3 to which the first initialization voltage VINT is applied, and a gate electrode connected to the initialization scan line SILj. The fourth transistor T4 may be turned on in response to the initialization scan signal SIj received through the initialization scan line SILj and then may apply the first initialization voltage VINT to the gate electrode of the first transistor T1 to perform an initialization operation of initializing the voltage of the gate electrode of first transistor T1.

The fifth transistor T5 includes a first electrode connected to the first driving voltage line VL1, a second electrode connected to the second electrode of the first transistor T1, and a gate electrode connected to the light emission control line EMLj.

The sixth transistor T6 includes a first electrode connected to the second electrode of the first transistor T1, a second electrode connected to an anode of the light emitting element ED, and a gate electrode connected to the light emission control line EMLj.

The fifth transistor T5 and the sixth transistor T6 are simultaneously turned on in response to the light emission control signal EMj received through the light emission control line EMLj. The first driving voltage ELVDD applied through the turned-on fifth transistor T5 may be compensated through the diode-connected first transistor T1 and then applied to the light emitting element ED.

The seventh transistor T7 includes a first electrode connected to the second electrode of the sixth transistor T6, a second electrode connected to the fourth driving voltage line VL4 to which the second initialization voltage AINT is applied, and a gate electrode connected to the black scan line SBLj. The seventh transistor T7 may be turned on in response to the black scan signal SBj received through the black scan line SBLj and may apply the second initialization voltage AINT to the anode of the light emitting element ED to perform an initialization operation of initializing the anode of the light emitting element ED.

As described above, the one end of the capacitor Cst is connected to the gate electrode of the first transistor T1, and the other end of the capacitor Cst is connected to the first driving voltage line VL1. A cathode of the light emitting element ED may be connected to the second driving voltage line VL2 to which the second driving voltage ELVSS is applied.

Referring to FIGS. 3, 5A, and 5B, an embodiment of the display device DD may operate in a variable frequency mode in which a driving frequency is varied. FIG. 5A illustrates a case in which the display panel DP operates at a first driving frequency, and FIG. 5B illustrates a case in that the display panel DP operate at a second driving frequency. In an embodiment, for example, the first drive frequency may be higher than the second drive frequency. The first drive frequency may be about 60 hertz (Hz), about 120 Hz, about 240 Hz, and about 480 Hz, and the second drive frequency may be about 30 Hz, about 10 Hz, about 2 Hz, and about 1 Hz.

At the first driving frequency, the display panel DP may display an image during a plurality of first driving frames F1, and at the second driving frequency, the displaying panel DP may display the image during a plurality of second driving frames F2. A duration of the first driving frame F1 is different from a duration of the second driving frame. Each of the first and second driving frames F1, F2 may include a writing frame WF and at least one holding frame HF1, HF2, HF3. The number of the holding frames HF1, HF2, and HF3 included in each driving frame may vary depending on the driving frequency.

When the driving frequency of the display panel DP is about 1 Hz, one driving frame may be generated for about 1 second. The driving frame may include one writing frame WF and 59 holding frames. When the driving frequency of the display panel DP is about 10 Hz, 10 driving frames may be generated for about 1 second. The driving frame may include one writing frame WF and 5 holding frames. The duration of the write frame WF may be the same as the duration of each of the holding frames HF1, HF2, and HF3. In addition, the duration of the write frame WF for each drive frame may be the same as each other.

The write scan signal SWj, the initialization scan signal SIj, the compensation scan signal SCj, and the black scan signal SBj may be activated during the write frame WF. The black scan signal SBj is activated in the holding frames HF1, HF2, and HF3, and the write scan signal SWj, the initialization scan signal SIj, and the compensation scan signal SCj are deactivated. The light emission control signal EMi may be activated in the writing frame WF and the holding frames HF1, HF2, and HF3. Alternatively, at least one selected from the initialization scan signal SIj and the compensation scan signal SCj may be further activated in the holding frames HF1, HF2, and HF3.

When the initialization scan signal SIj of high level is provided through the initialization scan line SILj during an initialization period AP1, the fourth transistor T4 is turned on in response to initialization scan signal SIj of the high-level. The first initialization voltage VINT is transmitted to the gate electrode of the first transistor T1 through the turned-on fourth transistor T4, and the gate electrode of first transistor T1 is initialized by the first initialization voltage VINT.

Next, when the compensation scan signal SCj of a high level is supplied through the compensation scan line SCLj during a compensation period AP2, the third transistor T3 is turned on. The compensation period AP2 may be non-overlapping with the initialization period AP1. During the compensation period AP2, the first transistor T1 is diode connected by the turned-on third transistor T3 and is biased in a forward direction.

In an embodiment, for example, an activation period of the compensation scan signal SCj (i.e., a period corresponding to the compensation period AP2) is defined as a period in which the compensation scan signal SCj has a high level, and an activation period of an initialization scan signal SIj (i.e., a period corresponding to the initialization period AP1) is defined as a period in which the initialization scan signal SJ has a high level. The activation period of the compensation scan signal SCj may be non-overlapping with the activation period of the initialization scan signal SIj. The activation period of the initialization scan signal SIj may precede the activation period of the compensation scan signal SCj. In an embodiment where the third and fourth transistors T3 and T4 are P-type transistors, the activation period of the compensation scan signal SCj (i.e., a period corresponding to the compensation period AP2) may be defined as a period in which the compensation scan signal SCj has a low level, and the activation period of the initialization scan signal SIj (i.e., a period corresponding to the initialization section AP1) may be defined as a period in which the initialization scan signal SJ has a low level.

The compensation period AP2 may include a data writing period AP3 in which the write scan signal SWj is generated at a low level. The second transistor T2 is turned on by the write scan signal SWj of a low level during the data write period AP3. Then, a compensation voltage (Di-Vth), which is obtained by reducing the data signal Di supplied from the data line DLi by a threshold voltage (Vth) of the first transistor T1, is applied to the gate electrode of the first transistor T1. That is, the potential of the gate electrode of the first transistor T1 may be the compensation voltage (Di-Vth).

The first driving voltage ELVDD and the compensation voltage (Di-Vth) may be applied to both ends of the capacitor Cst, and a charge corresponding to a voltage difference between both ends of the capacitor Cst may be stored in the capacitor Cst.

In such an embodiment, during the black period AP4, the seventh transistor T7 is turned on by being supplied with the black scan signal SBj of a low level through the black scan line SBLj. The driving current Id may be drained through the seventh transistor T7 as the bypass current Ibp, and as a result, the anode of the light emitting element ED may be initialized.

Next, the light emission control signal EMj supplied from the light emission control line EMLj is changed from the high level to the low level. The fifth transistor T5 and the sixth transistor T6 are turned on by the light emission control signal EMj of the low level. Then, the driving current Id corresponding to a voltage difference between the gate voltage of the gate electrode of the first transistor T1 and the first driving voltage ELVDD is generated, and the driving current Id is supplied to the light emitting element ED through the sixth transistor T6, so that the current Ied flows through the light emitting device ED.

In such an embodiment, each of the holding frames HF1, HF2, and HF3 does not include the initialization period AP1, the compensation period AP2, and the data writing period AP3, and may include only the black period AP4. During the holding frames HF1, HF2, and HF3, the initialization scan signal SIj, the compensation scan signal SCj, and the write scan signal SWj remain in an inactive state. Therefore, during the holding frames HF1, HF2, and HF3, the light emitting element ED may maintain the current Ied flowing to the light emitting device ED during the writing frame WF, and each of the holding frames HB1, HF2, and HB3 may maintain the displayed image during the writing frames WF.

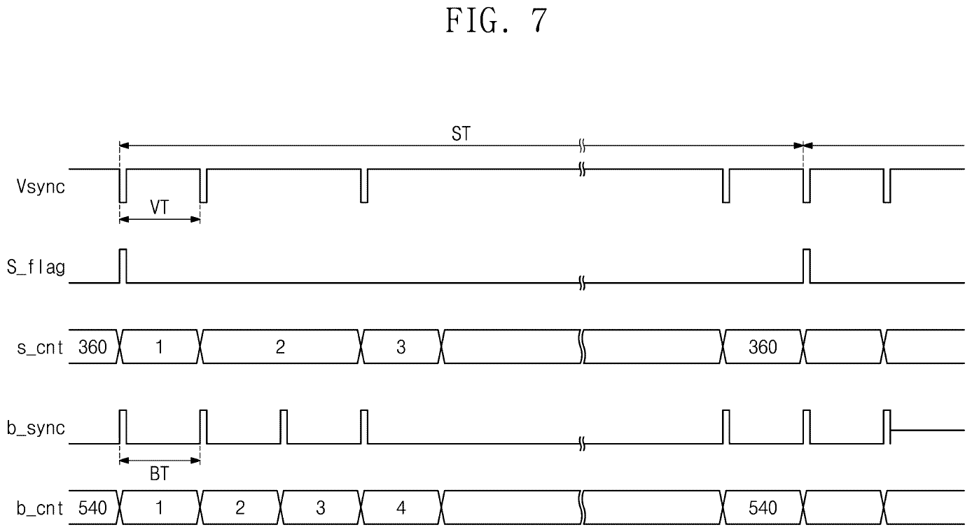

FIG. 6A is a block diagram of an afterimage compensation circuit according to an embodiment of the present disclosure. FIG. 6B is a block diagram of the deterioration data compensation unit shown in FIG. 6A. FIG. 7 is a signal timing diagram for describing an operation of the deterioration data compensation unit illustrated in FIG. 6B.

Referring to FIGS. 6A and 6B, in an embodiment, the afterimage compensation circuit 150 includes a compensation unit 151, an accumulating memory 152, and a sampling unit 153, a deterioration data generation unit 154, a deterioration data compensation unit 155, and a volatile memory 156.

The compensation unit 151 receives the input image signals RGB for each driving frame, and compensates the input image signals RGB based on accumulated deterioration data ADD stored in the accumulating memory 152 to generate compensation image signals RGB′.

The accumulating memory 152 accumulates a final deterioration data F_IDD in the previously stored accumulated deterioration data and stores as the accumulated deterioration data ADD. The accumulated deterioration data ADD is provided to the compensation unit 151, and the compensation unit 151 performs deterioration compensation processing based on the accumulated deterioration data ADD.

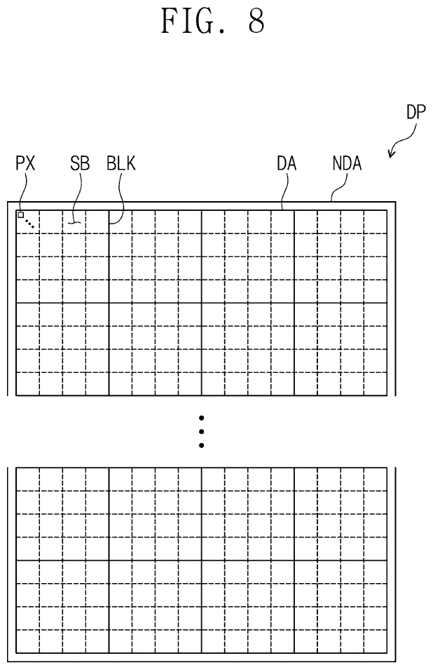

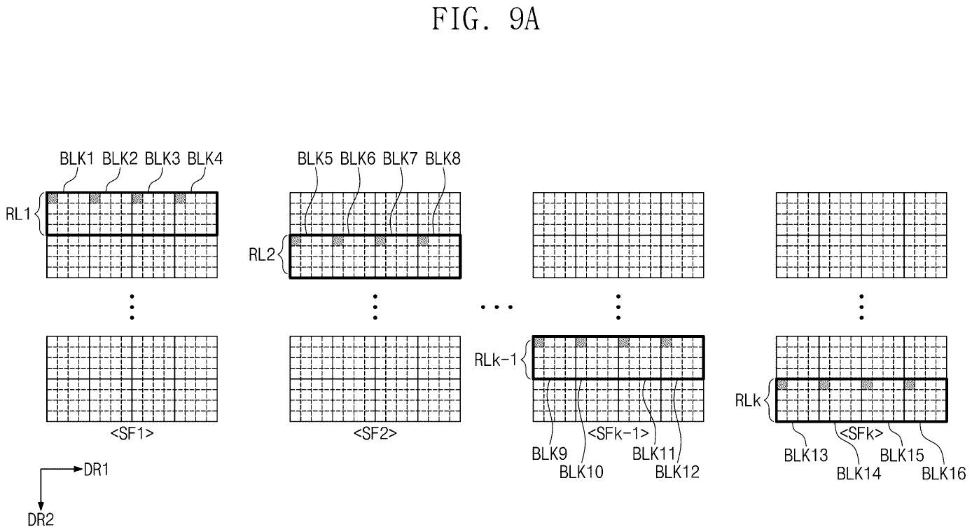

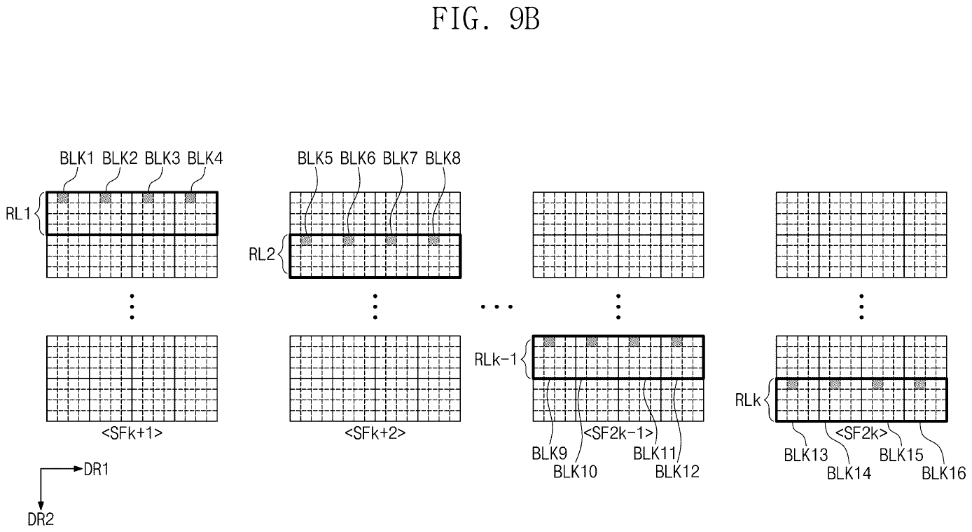

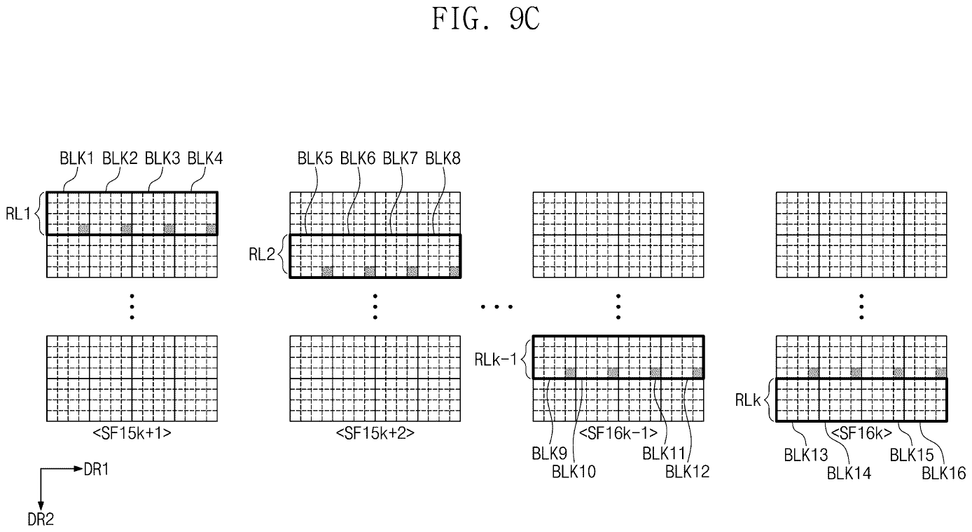

The sampling unit 153 may receive the compensation image signals RGB′ from the compensation unit 151 and sample some image signals from the compensation image signals RGB′. In an embodiment, for example, the sampling unit 153 may perform a sampling operation for one sampling frame. The sampling signal sampled from the compensation image signals RGB′ by the sampling unit 153 may be provided to the deterioration data generation unit 154. The sampling process of the sampling unit 153 will be described in detail with reference to FIGS. 8 to 9C.

The deterioration data generation unit 154 may generate deterioration data IDD for the display panel DP based on the sampling signal. The deterioration data generation unit 154 may generate the deterioration data IDD for the display panel DP for each sampling period. A plurality of sampling frames may be generated during the sampling period. The deterioration data generation unit 154 provides the deterioration data IDD to the deterioration data compensation unit 155. The deterioration data compensation unit 155 calculates an average frequency based on the number of sampling frames generated in the sampling period and a reference frequency BF, and applies the average frequency to the deterioration data IDD to generate final deterioration data F_IDD.

Referring to FIGS. 6B and 7, in an embodiment, the deterioration data compensation unit 155 may include a frequency calculation unit 155a and a data processing unit 155b. The frequency calculation unit 155a receives a reference synchronization signal b_sync synchronized (or interlocking) with the reference frequency BF, a sampling flag signal s_flag indicating the sampling period ST, and a vertical synchronization signal Vsync synchronized (or interlocking) with a driving frequency of the display panel DP. That is, the frequency calculation unit 155a is supplied with the reference sync signal b_sync that is locked to the reference frequency BF, the sampling flag signal s_flag that designates the sampling period ST, and the vertical sync signal Vsync that is synchronized to the display panel DP's driving frequency.

The frequency calculation unit 155a may include a first counting unit CNP1, a second counting unit CNP2, and a calculation unit CAP. The first counting unit CNP1 receives the vertical synchronization signal Vsync and the sampling flag signal s_flag, and counts the number of sampling frames based on the vertical synchronization signal Vsync during one sampling period ST. The first counting unit CNP1 outputs the counted result value as a first counting value s_cnt.

In an embodiment, as shown in FIG. 7, a period VT of the vertical synchronization signal Vsync in the variable frequency mode may vary depending on the driving frequency. The sampling period ST is started at a time point when the sampling flag signal s_flag is activated in a high state (that is, a current activation time point), and may be defined as a period from the current activation time point to a next activation time point. The first counting unit CNP1 may count the number of times the vertical synchronization signal Vsync is activated in the sampling period ST as the number of sampling frames. FIG. 7 illustrates a case where the first counting value s_cnt is “360”, but embodiments of the present disclosure are not limited thereto, and the first counting value s_cnt may vary depending on the resolution of the display panel DP (see FIG. 3), the sampling period ST, and the like.

The second counting unit CNP2 counts the number of reference frames based on the reference synchronization signal b_sync during one sampling period ST, and outputs the counted result value as a second counting value b_cnt. In an embodiment, as illustrated in FIG. 7, although the driving frequency of the display panel DP is varied in the variable frequency mode, the reference frequency BF may be fixed. That is, the period BT of the reference synchronization signal b_sync during the sampling period ST may maintain a constant value regardless of the driving frequency. The second counting unit CNP2 may count the number of times the reference synchronization signal b_sync is activated in the sampling period ST as the number of reference frames. FIG. 7 illustrates a case where the second counting value b_cnt is “540”, but embodiments of the present disclosure are not limited thereto, and the second counting value b_cnt may vary depending on the reference frequency BF, the sampling period ST, or the like.

The calculation unit CAP may calculate a frequency weight based on the first counting value s_cnt and the second counting value b_cnt. In an embodiment, for example, the frequency weight is defined as a value obtained by dividing the first counting value s_cnt by the second counting value b_cnt. The calculation unit CAP may calculate an average frequency AF by multiplying the frequency weight by the reference frequency BF. Alternatively, the frequency weight may be defined as a value obtained by dividing the first counting value s_cnt by a value obtained by adding 1 to the second counting value b_cnt.

The data processing unit 155b may generate a value obtained by dividing the deterioration data IDD by the average frequency AF as the final deterioration data F_IDD. The deterioration data compensation unit 155 may accumulate the final deterioration data F_IDD in the accumulating memory 152. The accumulated deterioration data ADD may be stored in the volatile memory 156.

In such an embodiment, even when the driving frequency varies during the sampling period ST in the variable frequency mode, information on the driving frequency may be reflected in the final deterioration data F_IDD as the average frequency AF. As a result, as the input image signal RGB is compensated based on the final deterioration data F_IDD, it is possible to effectively prevent the input image signal RGB from being incorrectly compensated in the variable frequency mode.

FIG. 8 is a plan view of a display panel according to an embodiment of the present disclosure. FIGS. 9A to 9C are diagrams illustrating a sampling process for each of sampling periods according to an embodiment of the present disclosure.

Referring to FIG. 8, in an embodiment, the display panel DP may include a display area DA for displaying an image and a non-display area NDA adjacent to the display area DA. The display area DA of the display panel DP may include a plurality of blocks BLK. The display area DA may be divided into the plurality of blocks BLK. In FIG. 8, a case where the display area DA is divided into 16 blocks BLK is illustrated as an example, but the number of blocks BLK is not limited thereto.

Over time, an afterimage due to deterioration may occur in the display area DA of the display panel DP. The afterimage of the display area DA may have a difference in degree between the plurality of blocks BLK. The display device DD according to an embodiment of the present disclosure may compensate for luminance of an image displayed on each block BLK of the display panel DP based on deterioration information on each of the plurality of blocks BLK.

In an embodiment, a plurality of sub-blocks SB may be defined in each of the plurality of blocks BLK. At least one pixel PX may be disposed in each sub-block SB. A size of each of the sub-blocks SB may be determined according to the number of pixels PX included in each sub-block SB. That is, as the number of the pixels PX included in each sub-block SB increases, the size of each sub-block SB may increase, and conversely, as the number of pixels PX included in each sub-block SB decreases, the size of each sub-block SB may decrease. In an embodiment, for example, 64 pixels PX may be disposed in each sub-block SB.

In FIG. 8, an embodiment in which 16 sub-blocks SB are included in one block BLK is shown as an example, but the number of the sub-blocks SB in one block BLK is not limited thereto. In such an embodiment, compensation for deterioration (hereinafter, deterioration compensation) may be performed in units of sub-blocks SB. As the number of sub-blocks SB included in each block BLK increases, the deterioration compensation may become more precise.

Referring to FIGS. 6A to 9C, the sampling unit 153 may receive the compensation image signals RGB′ from the compensation unit 151 and sample some image signals from the compensation image signals RGB′.

In an embodiment, for example, the sampling unit 153 performs sampling on some of the blocks BLK1 to BLK16 in units of a reference frame. In an embodiment, for example, the reference frame may be one frame. FIG. 9A to FIG. 9C illustrate a case where the sampling unit 153 performs sampling on four blocks per frame as an example, but embodiments of the present disclosure are not limited thereto.

The sampling unit 153 may set sampling lines RL1, RL2 to RLk−1, and RLk in the display area DA and then sequentially select one of the sampling lines RL1 to RLk-2 in the first direction DR1 or the second direction DR2 to perform a sampling operation. FIGS. 9A to 9C illustrate an embodiment in which each of the sampling lines RL1, RL2 to RLk−1, and RLk extends in the first direction DR1 and is arranged in the second direction DR2 as an example, but embodiments the present disclosure are not limited thereto. In an embodiment where the display area DA includes 4×k blocks, each of the sampling lines RL1, RL2 to RLk−1, and RLk may include four blocks, and a total of k sampling frames may be desired to sample all of the blocks BLK1 to BLK16 once. Here, k is a natural number greater than 1. The k sampling frames that sample the k sampling lines RL1, RL2 to RLk−1, and RLk, respectively, may be set as the sampling period.

In an embodiment, for example, each of the blocks BLK1 to BLK16 may include 16 sub-blocks. In such an embodiment where one sub-block among the 16 sub-blocks is sampled per one sampling frame, 16 sampling frames are desired in order to sample a total of the 16 sub-blocks. Therefore, a total of 16×k sampling frames may be desired to sample all the sub-blocks included in all the blocks BLK1 to BLK16 once.

As shown in FIG. 9A, in a first sampling frame SF1, sampling on blocks (i.e., the first to fourth blocks BLK1 to BLK4) located on the first sampling line RL1 is performed. In the first sampling frame SF1, the compensation image signals for the first sub-blocks located in each of the first to fourth blocks BLK1 to BLK4 may be sampled as a first sampling signal. In a second sampling frame SF2, the compensation image signals for the first sub-blocks located in each of the blocks located in the second sampling line RL2 (that is, the fifth to eighth blocks BLK5 to BLK8) may be sampled as a second sampling signal. In a (k−1)-th sampling frame SFk−1, sampling on the blocks (that is, the ninth to twelfth blocks BLK9 to BLK12) located in the (k−1)-th sampling line RLk−1 is performed. In the (k−1)-th sampling frame SFk−1, the compensation image signals for the first sub-blocks located in each of the ninth to twelfth blocks BLK9 to BLK12 may be sampled as a (k−1)-th sampling signal. In a k-th sampling frame SFk, the compensation image signals for the first sub-blocks located in each of the blocks located in the k-th sampling line RLk (that is, the thirteenth to sixteenth blocks BLK13 to BLK16) may be sampled as a k-th sampling signal.

In such an embodiment, as described above, k sampling frames may be generated during one sampling period, and k sampling signals may be sampled during the k sampling frames, respectively.

When a next sampling period is started as shown in FIG. 9B, the compensation image signals for the second sub-blocks located in each of the first to fourth blocks BLK1 to BLK4 of the first sampling line RL1 in a (k+1)-th sampling frame SFk+1 may be sampled as a (k+1)-th sampling signal. In a (k+2)-th sampling frame SFk+2, the compensation image signals for the second sub-blocks located in each of the fifth to eighth blocks BLK5 to BLK8 of the second sampling line RL2 may be sampled as a (k+2)-th sampling signal. In a (2k−1)-th sampling frame SF2k−1, the compensation image signals for the second sub-blocks located in each of the ninth to twelfth blocks BLK9 to BLK12 of the (k−1)-th sampling line RLk−1 may be sampled as a (2k−1)-th sampling signal. In a 2k-th sampling frame SF2k, the compensation image signals for the second sub-blocks located in each of the thirteenth to sixteenth blocks BLK13 to BLK 16 of the k-th sampling line RLk may be sampled as a 2k-th sampling signal.

As shown in FIG. 9C, in a (15k+1)-th sampling frame SF15k+1, the compensation image signals for the sixteenth sub-blocks located in each of the first to fourth blocks BLK1 to BLK4 of the first sampling line RL1 may be sampled as a (15k+1-th sampling signal. In the (15k+2)-th sampling frame SF15k+2, the compensation image signals for the sixteenth sub-blocks located in each of the fifth to eighth blocks BLK5 to BLK8 of the second sampling line RL2 may be sampled as a (15k +2)-th sampling signal. In a (16k−1)-th sampling frame SF16k−1, the compensation image signals for the sixteenth sub-blocks located in each of the ninth to twelfth blocks BLK9 to BLK12 of the (k−1)-th sampling line RLk−1 may be sampled as a (16k−1)-th sampling signal. In the 16th k-th sensing frame SF16k, the compensation image signals for the sixteenth sub-blocks located in each of the thirteenth to sixteenth blocks BLK13 to BLK16 of the k-th sampling line RLk may be sampled as a 16k-th sampling signal.

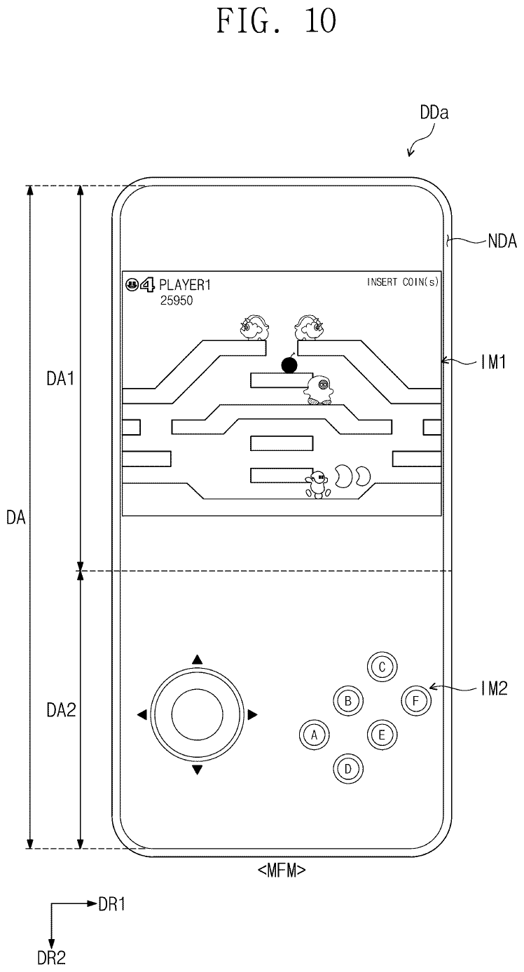

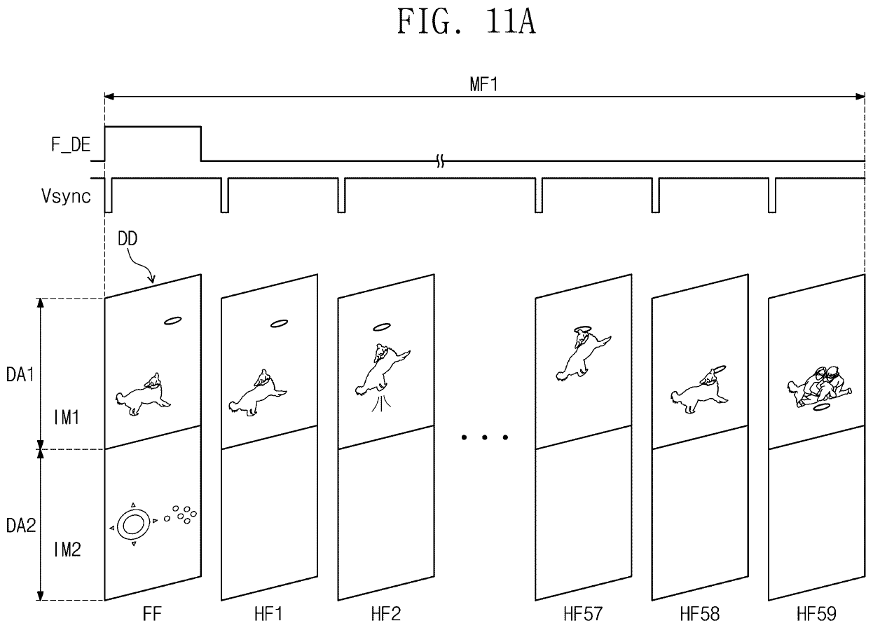

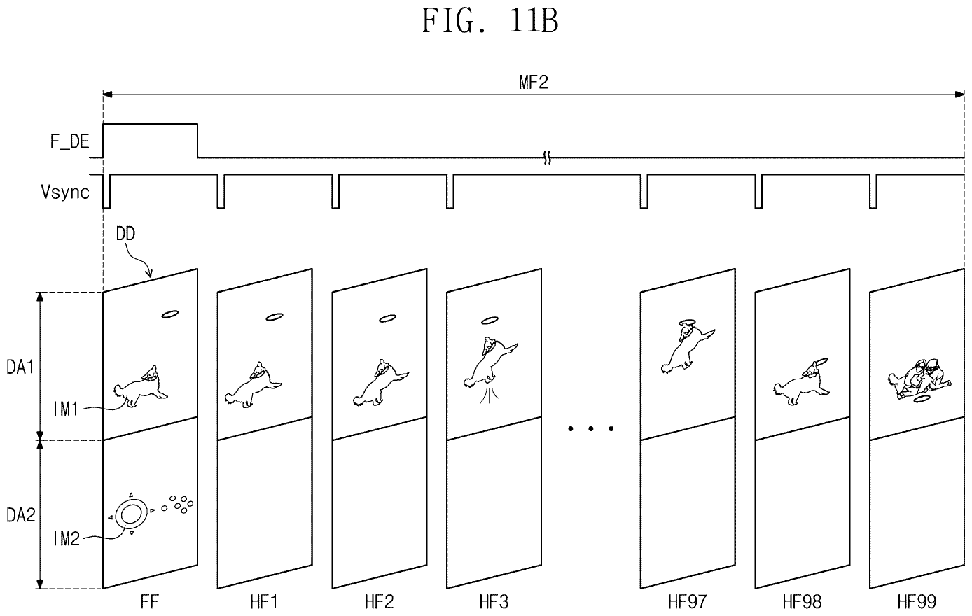

FIG. 10 is a plan view illustrating a screen of a display device according to an embodiment of the present disclosure. FIG. 11A is a diagram for describing an operation of a display device in a normal frequency mode according to an embodiment of the present disclosure. FIG. 11B is a diagram for describing an operation of a display device in a multi-frequency mode according to an embodiment of the present disclosure.

Referring to FIG. 10, in an embodiment, the display device DDa may display an image in a normal frequency mode or a multi-frequency mode. In the normal frequency mode, the display area DA of the display device DDa is not divided into a plurality of display areas having different driving frequencies. That is, the display area DA operates at one driving frequency in the normal frequency mode, and the driving frequency of the display area DA in the normal frequency mode can be defined as the normal frequency.

In the multi-frequency mode MFM, the display area DA of the display device DDa is divided into the plurality of display areas having different driving frequencies. In an embodiment, for example, in the multi-frequency mode MFM, the display area DA may include a first display area DA1 and a second display area DA2. The first and second display areas DA1 and DA2 are disposed adjacent to each other in the second direction DR2. A driving frequency (or a first frequency) of the first display area DA1 may be a frequency higher than or equal to the normal frequency, and a driving frequency (or a second frequency) of the second display area DA2 may be a frequency lower than the normal frequency. In an embodiment, for example, where the normal frequency is about 60 Hz, the driving frequency of the first display area DA1 may be about 90 Hz, about 100 Hz, about 120 Hz, about 240 Hz, about 480 Hz, or the like, and the driving frequency of the second display area DA2 may be about 1 Hz, about 20 Hz, about 30 Hz, about 40 Hz, or the like.

In an embodiment, for example, the first display area DA1 may be an area that displays a moving image (hereinafter, referred to as a first image IM1) suitable for high-speed driving, and the second display area DA2 may be an area that displays a still image that is typically displayed with lower driving speed, e.g., a text image having a long change period (hereinafter, referred as a second image IM2), or the like. Therefore, when the still image and the moving image are simultaneously displayed on the screen of the display device DDa, by operating the display device DDa in the multi-frequency mode MFM, it is possible to substantially reduce the overall power consumption while improving the display quality of the moving image.

In the multi-frequency mode MFM, an image may be displayed in the display area DA of the display device DDa for a plurality of driving frames. Each of the driving frames may include a full frame FF in which the first display area DA1 and the second display area DA2 are driven, and partial frames in which only the first display area DA1 is driven.

As illustrated in FIG. 11A, when the first display area DA1 operates at about 60 Hz and the second display area DA2 operates at about 1 Hz, the driving frame MF1 may include one full frame FF and 59 partial frames HF1 to HF59. During the driving frame MF1, the first display area DA1 of the display device DDa may display 60 first images IM1 corresponding to the full frame FF and the 59 partial frames HF1 to HF59, and the second display area DA2 may display one second image IM2 corresponding to the full frame FF.

As shown in FIG. 11B, when the first display area DA1 operates at about 100 Hz and the second display area DA2 operates at about 1 Hz, the driving frame MF2 may include one full frame FF and 99 partial frames HF1 to HF99. During the driving frame MF2, 100 first images IM1 corresponding to the full frame FF and the 99 partial frames HF1 to HF99 may be displayed in the first display area DA1 of the display device DDa, and one second image IM2 corresponding to the full frame FF may be displayed in a second display area DA2.

The number of the partial frames HF1 to HF99 included in each driving frame may vary depending on the driving frequencies of the first and second display areas DA1 and DA2. Each of the partial frames HF1 to HF59 and HF1 to HF99 may have a same duration as that of the full frame FF.

In an embodiment, as described above, in the multi-frequency mode MFM in which the high-frequency area (that is, the first display area DA1) and the low-frequency area (that is, the second display area DA2) exist in one display region DA, the vertical synchronization signal Vsync may be synchronized or interlocked with the driving frequency of the first display area DA1. In an embodiment, for example, the vertical synchronization signal Vsync may be activated 60 times in the driving frame MF1, and the vertical synchronization signal Vsync may be activated 100 times in the driving framework MF2. A full data enable signal F_DE may be activated interlocking with the full frame FF. In an embodiment, for example, the full data enable signal F_DE may be activated only once in each of the driving frames MF1 and MF2.

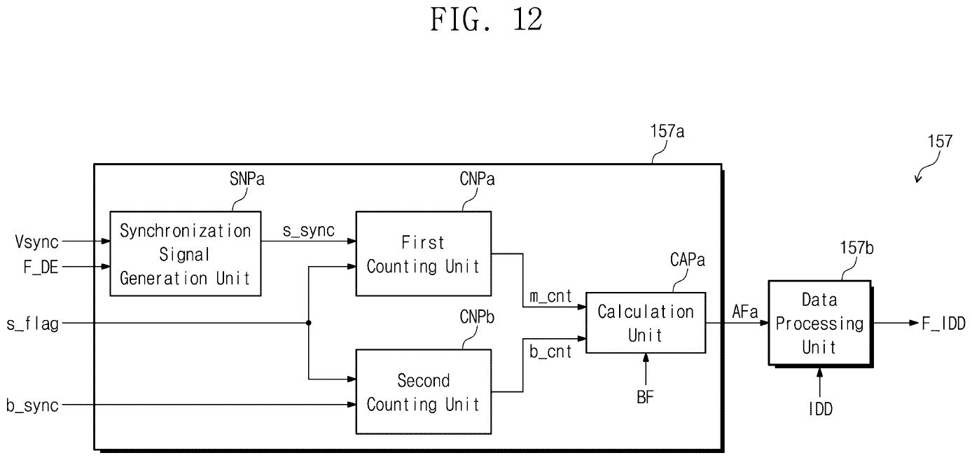

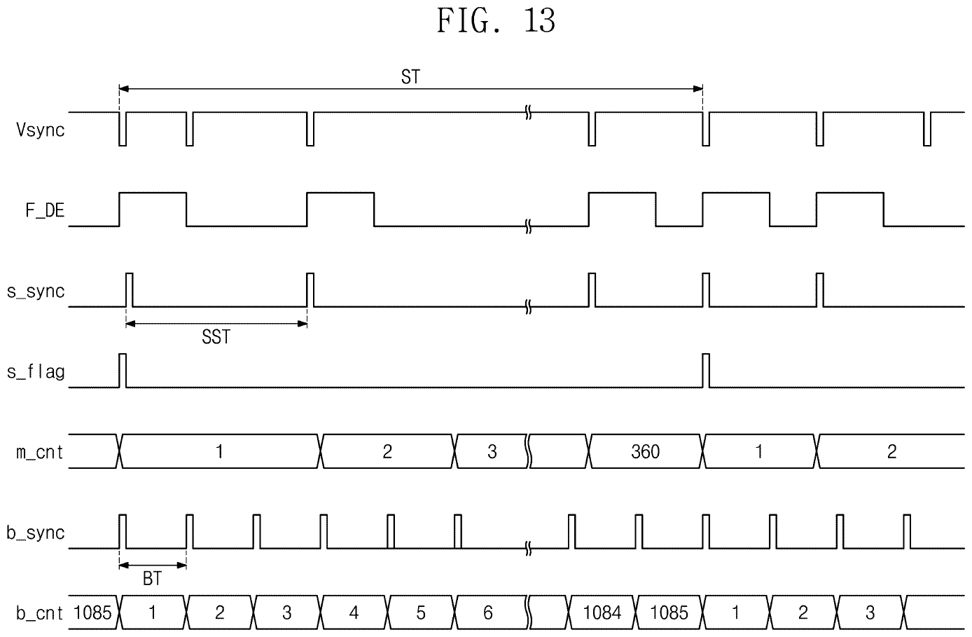

FIG. 12 is a block diagram of an afterimage compensation circuit according to an embodiment of the present disclosure, and FIG. 13 is a signal timing diagram for describing an operation of the deterioration data compensation unit illustrated in FIG. 12.

Referring to FIGS. 12 and 13, the deterioration data compensation unit 157 according to an embodiment of the present disclosure may include a frequency calculation unit 157a and a data processing unit 157b. The frequency calculation unit 157a receives a reference synchronization signal b_sync synchronized (or interlocking) with the reference frequency BF, a sampling flag signal s_flag indicating the sampling period ST, a vertical synchronization signal Vsync synchronized (or interlocking) with a driving frequency of the display panel DP, and a full data enable signal F_DE synchronized (or interlocking) with the full frame FF (see FIG. 11A).

The frequency calculation unit 157a may include a synchronization signal generation unit SNPa, a first counting unit CNPa, a second counting unit CNPb, and a calculation unit CAPa. The synchronization signal generation unit SNPa may receive the vertical synchronization signal Vsync and the full data enable signal F_DE, and generate a sampling synchronization signal s_sync based on the vertical synchronization signal Vsync and the full data enabling signal F_DE. In such an embodiment of the present disclosure, the sampling synchronization signal s_sync may be activated at each time point when both the vertical synchronization signal Vsync and the full data enable signal F_DE are activated. In an embodiment, for example, the period SST of the sampling synchronization signal s_sync may be identical to the period of the full data enable signal F_DE.

In the multi-frequency mode MFM, the period SST of the sampling synchronization signal s_sync may vary depending on the driving frequencies of the first and second display regions DA1 and DA2. The sampling period ST may be started at a time point when the sampling flag signal s_flag is activated in a high state (that is, a current activation time point), and may be defined as a period from the current activation time point to a next activation time point.

The first counting unit CNPa receives the sampling synchronization signal s_sync and the sampling flag signal s_flag, and counts the number of sampling frames based on the sampling synchronization signal s_sync during one sampling period ST. The first counting unit CNPa outputs the counted result value as the first counting value m_cnt. The first counting unit CNPa may count the number of times the sampling synchronization signal s_sync is activated in the sampling period ST as the number of sampling frames. FIG. 13 illustrates a case where the first counting value m_cnt is “360”, but embodiments of the present disclosure are not limited thereto, and the first counting value m_cnt may vary depending on the resolution of the display panel DP (see FIG. 3), the sampling period ST, or the like.

The second counting unit CNPb counts the number of reference frames based on the reference synchronization signal b_sync during one sampling period ST, and outputs the counted result value as the second counting value b_cnt. As illustrated in FIG. 13, in an embodiment, the driving frequencies of the first and second display areas DA1 and DA2 are varied in the multi-frequency mode MFM, but the reference frequency BF may be fixed. That is, the period BT of the reference synchronization signal b_sync during the sampling period ST may maintain a constant value regardless of the driving frequency. The second counting unit CNPb may count the number of times the reference synchronization signal b_sync is activated in the sampling period ST as the number of reference frames. FIG. 13 illustrates a case where the second counting value b_cnt is “1085”, but embodiment of the present disclosure are not limited thereto, and the second counting value b_cnt may vary depending on the reference frequency BF, the sampling period ST, or the like.

The calculation unit CAPa may calculate a frequency weight based on the first counting value m_cnt and the second counting value b_cnt. In an embodiment, for example, the frequency weight is defined as a value obtained by dividing the first counting value m_cnt by the second counting value b_cnt. The calculation unit CAPa may calculate an average frequency AFa by multiplying the frequency weight by the reference frequency BF. Alternatively, the frequency weight may be defined as the first counting value m_cnt divided by a value obtained by adding 1 to the second counting value b_cnt.

The data processing unit 157b may generate a value obtained by dividing the deterioration data IDD by the average frequency AFa as the final deterioration data F_IDD. The deterioration data compensation unit 157 may accumulate the final deterioration data F_IDD in the accumulating memory 152 (see FIG. 6A). The accumulated deterioration data ADD may be stored in the volatile memory 156 (see FIG. 6A).

In such an embodiment, even when the first and second driving frequencies vary during the sampling period ST in the multi-frequency mode, information on the first and second drive frequencies may be reflected in the final deterioration data F_IDD as the average frequency AFa. As a result, as the input image signal RGB is compensated based on the final deterioration data F_IDD, it is possible to effectively prevent the input image signal RGB from being incorrectly compensated in the multi-frequency mode.

The display module according to embodiments of the present disclosure may be applied to various electronic apparatuses. The electronic apparatus according to an embodiment includes the above-described display module, and may further include a module or a device having an additional function other than the display device.

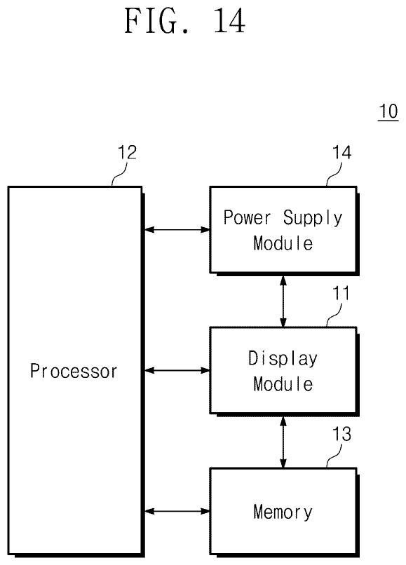

FIG. 14 is a block diagram of an electronic apparatus according to an embodiment of the present disclosure.

Referring to FIG. 14, an electronic apparatus 10 according to an embodiment may include a display module 11, a processor 12, a memory 13, and a power supply module 14.

The processor 12 may control operation of the display module 11, and may include at least one selected from a central processing unit (CPU), an application processor (AP), a graphics processing unit (GPU), a communication processor (CP), an image signal processor (ISP), and a controller.

The memory 13 may store data information used for operation of the processor 12 or the display module 11. When the processor 12 executes the application stored in the memory 13, the image data signal and/or the input control signal are transmitted to the display module 11, and the display module 11 may process the received signal to output image information through the display screen.

The power supply module 14 may include a power supply module such as a power adapter or a battery device, and a power conversion module that converts power supplied by the power supply module to generate power used for operation of the electronic apparatus 10.

At least one of the components of the electronic apparatus 10 described above may be included in the display module according to the above-described embodiments. In addition, some of the individual modules that are functionally included in one module may be included in the display module, and other individual modules may be provided separately from the display module. In an embodiment, for example, the display module 11 may be included in a display device, and the processor 12, the memory 13, and the power supply module 14 may be provided in the form of other devices within the electronic apparatus 10 other than the display device.

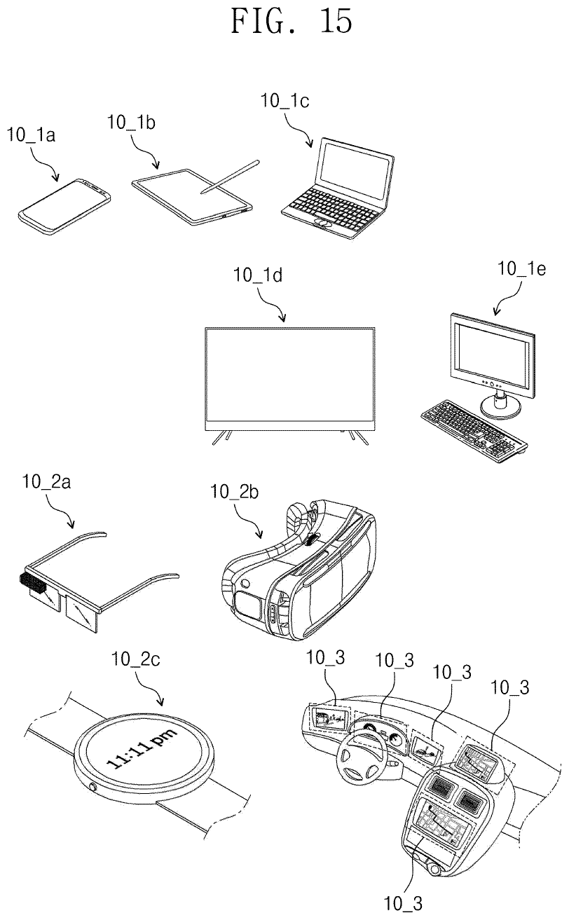

FIG. 15 is a schematic diagram illustrating electronic apparatuses in accordance with various embodiments.

Referring to FIG. 15, various electronic apparatuses to which the display module according to the embodiments is applied may include electronic apparatuses for image display such as a smartphone 10_1a, a tablet personal computer (PC) 10_1b, a laptop computer 10_1c, a television (TV) 10_1d, and a desk monitor 10_1e, as well as wearable electronic apparatus such as smart glasses 10_2a, a head mounted display 10_2b, and a smart watch 10_2c, and an electronic apparatus 10_3 for a vehicle such as a center information display (CID) and a room mirror display disposed on an instrument panel, a center fascia, and a dashboard of a vehicle.

According to embodiments of the present disclosure, even when the driving frequency of the display panel is varied during the sampling period in the variable frequency mode or the multi-frequency mode, information on the driving frequency can be reflected in the final deterioration data as the average frequency. As a result, as the input image signal is compensated based on the final deterioration data, it is possible to effectively prevent the input image signal from being incorrectly compensated in the variable frequency mode or the multi-frequency mode.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A display device comprising:
a display panel in which a plurality of pixels are arranged; and
an afterimage compensation circuit which receives input image signals, and compensates the input image signals based on deterioration information about the display panel to generate compensation image signals,
the afterimage compensation circuit includes:
a deterioration data generation unit which generates deterioration data for the display panel for each sampling period;
a deterioration data compensation unit which calculates an average frequency based on a reference frequency and a number of sampling frames generated in the sampling period, and applies the average frequency to the deterioration data to generate a final deterioration data;
an accumulating memory in which the final deterioration data is accumulated; and
a compensation unit which receives an accumulated deterioration data stored in the accumulating memory as the deterioration information, and compensates the input image signals based on the accumulated deterioration data to generate the compensation image signals.

2. The display device of claim 1, wherein the deterioration data compensation unit includes:
a frequency calculation unit which calculates a frequency weight based on a number of reference frames counted based on a reference synchronization signal generated at the reference frequency during the sampling period and the number of the sampling frames, and multiplies the frequency weight by the reference frequency to calculate the average frequency; and
a data processing unit which generates, as the final deterioration data, a value obtained by dividing the deterioration data by the average frequency.

3. The display device of claim 2, wherein:
a driving frequency of the display panel is varied during the sampling period, and the reference frequency is fixed.

4. The display device of claim 3, wherein the frequency calculation unit includes:
a first counting unit which receives a vertical synchronization signal synchronized with the driving frequency of the display panel and a sampling flag signal indicating the sampling period, counts the number of the sampling frames based on the vertical synchronization signal and the sampling flag signal, and generates a counted result value as a first counting value; and
a second counting unit which receives the reference synchronization signal and the sampling flag signal, counts the number of the reference frames based on the reference synchronization signal and the sampling flag signal, and generates a counted result value as a second counting value.

5. The display device of claim 4, wherein
the frequency weight is defined as a value obtained by dividing the first counting value by the second counting value.

6. The display device of claim 4, wherein
the frequency weight is defined as a value obtained by dividing the first counting value by a value obtained by adding 1 to the second counting value.

7. The display device of claim 4, wherein the first counting unit counts a number of times the vertical synchronization signal is activated in a period from a current activation time of the sampling flag signal to a next activation time of the sampling flag signal, as the number of the sampling frames.

8. The display device of claim 4, wherein the second counting unit counts a number of times the reference synchronization signal is activated in a period from a current activation time of the sampling flag signal to a next activation time of the sampling flag signal, as the number of the reference frames.

9. The display device of claim 2, wherein the display panel comprises:
a first display area which operates at a first driving frequency and a second display area which operates at a second driving frequency lower than the first driving frequency,
the display panel displays an image for each driving frame, and
the driving frame includes a full frame and one or more partial frames.

10. The display device of claim 9, wherein the frequency calculation unit includes:
a synchronization signal generation unit which receives a vertical synchronization signal synchronized with the first driving frequency of the display panel and a full data enable signal synchronized with the full frame, and generates a sampling synchronization signal based on the vertical synchronization signal and the full data enable signal;
a first counting unit which receives the sampling synchronization signal and a sampling flag signal indicating the sampling period, counts the number of the sampling frames based on the sampling synchronization signal and the sampling flag signal, and generates a counted result value as a first counting value; and
a second counting unit which receives the reference synchronization signal and the sampling flag signal, counts the number of the reference frames based on the reference synchronization signal and the sampling flag signal, and generates a counted result value as a second counting value.

11. The display device of claim 10, wherein:
the frequency weight is defined as a value obtained by dividing the first counting value by the second counting value.

12. The display device of claim 10, wherein:
the frequency weight is defined as a value obtained by dividing the first counting value by a value obtained by adding 1 to the second counting value.

13. The display device of claim 10, wherein the first counting unit counts a number of times the sampling synchronization signal is activated in a period from a current activation time point of the sampling flag signal to a next activation time point of a sampling flag signal, as the number of the sampling frames.

14. The display device of claim 10, wherein the second counting unit counts a number of times the reference synchronization signal is activated in a period from a current activation time of the sampling flag signal to a next activation time of the sampling flag signal, as the number of the reference frames.

15. The display device of claim 10, wherein
a period of the sampling synchronization signal is varied during the sampling period, and a period of the reference synchronization signal is fixed.

16. The display device of claim 9, wherein
the reference frequency is lower than or equal to the first driving frequency, and is higher than the second driving frequency.

17. The display device of claim 1, wherein the display panel comprises a plurality of blocks, in each of which one or more pixels are arranged, and
wherein the afterimage compensation circuit further includes a sampling unit which samples one or more pixels of each of the plurality of blocks for each of the sampling frames.

18. The display device of claim 1, wherein the afterimage compensation circuit further comprises:
a volatile memory which stores the accumulated deterioration data.

19. An electronic apparatus comprising:
a display panel in which a plurality of pixels are arranged;
a driving controller including an afterimage compensation circuit which receives input image signals and compensates the input image signals based on deterioration information for the display panel to generate compensation image signals; and
a processor which provides the input image signals to the driving controller,
the afterimage compensation circuit includes:
a deterioration data generation unit which generates a deterioration data for the display panel for each sampling period;
a deterioration data compensation unit which calculates an average frequency based on a reference frequency and a number of sampling frames generated in the sampling period, and applies the average frequency to the deterioration data to generate a final deterioration data;
an accumulating memory in which the final deterioration data is accumulated; and
a compensation unit which receives an accumulated deterioration data stored in the accumulative memory as the deterioration information, and compensates the input image signals based on the accumulated deterioration data to generate the compensation image signals.

20. The electronic apparatus of claim 19, wherein the deterioration data compensation unit includes:
a frequency calculation unit which calculates a frequency weight based on a number of reference frames counted based on a reference synchronization signal generated at the reference frequency during the sampling period and the number of the sampling frames, and multiply the frequency weight by the reference frequency to calculate the average frequency; and
a data processing unit which generates a value obtained by dividing the deterioration data by the average frequency as the final deterioration data.
